(19) United States
(12) Patent Application Publication
(10) Pub. No.: US 2009/0104446 A1
(43) Pub. Date: Apr. 23, 2009

(54) Polymers for Protecting Materials from Damage

(76) Inventors: James Guillet, Don Mills (CA); Adam Hofheimer, Richmond, VA (US); Joel Zychick, Bethpage, NY (US); Michael N. Haynes, Keswick, VA (US)

Correspondence Address: MICHAEL N. HAYNES, 1341 HUNTERSFIELD CLOSE, KESWICK, VA, 22947, US

(21) Appl. No.: 12/261,486

(22) Filed: Oct. 30, 2008

Related U.S. Application Data
(62) Division of application No. 10/529,966, filed on Mar. 31, 2005.
(60) Provisional application No. 60/415,461, filed on Oct. 3, 2002.

(51) Int. Cl. B32B 9/04; C08G 73/02

(52) U.S. Cl. 428/411.1; 524/800

(57) ABSTRACT

Certain exemplary embodiments of compositions, and methods of applying the compositions to plants and/or other materials, are disclosed. Certain exemplary embodiments can provide a composition comprising water droplets comprising a dispersion of particles comprising a polymer comprising at least one hydrophobic substituent and at least one hydrophilic substituent. The polymer can be formed from polymerization and/or copolymerization. The composition, when applied to at least a portion of a surface of the materials, can reduce damage to the materials.

### CROSS-REFERENCE TO RELATED APPLICATIONS

This application is a divisional of and claims priority to pending U.S. patent application Ser. No. 10/529,966, filed 31 Mar. 2005, which is a National Stage of PCT Application PCT/US03/31385, filed 2 Oct. 2003 that claims priority from U.S. Provisional Application 60/415,461, filed 3 Oct. 2002. Incorporated by reference herein in its entirety is U.S. application Ser. No. 10/275,978, now U.S. Pat. No. 7,189,279, titled “Cross-linked Polymerlic Nanoparticles and Metal Nanoparticles Derived Therefrom”, filed 23 May 2003, which claims priority to and is a National Stage application of PCT Application PCT/CA01/00757, filed 28 May 2001, which claims priority to Canadian Application Number 2,309,575, filed 26 May 2000.

### BRIEF DESCRIPTION OF THE DRAWINGS

The claims and their wide variety of potential embodiments will be more readily understood through the following detailed description, with reference to the accompanying drawings in which:

FIG. 1 is a photograph of an atomic force microscope image of internally cross-linked nanoparticles;

FIG. 2 is a DSC plot of heat flow versus temperature for NIPAM;

FIG. 3 is a DSC plot of heat flow versus temperature for 20% MA and 80% NIPAM;

FIG. 4 is a DSC plot of heat flow versus temperature for 30% MA and 70% NIPAM;

FIG. 5 is a DSC plot of heat flow versus temperature for 23% acrylonitrile and 77% NIPAM; and

FIG. 6 is a simplified flow diagram for an exemplary method 6000.

### DETAIL DESCRIPTION

Certain exemplary embodiments of compositions, and methods of applying the compositions to materials, are disclosed. Certain exemplary embodiments can provide a composition comprising water droplets comprising a dispersion of particles comprising a polymer comprising at least one hydrophobic substituent and at least one hydrophilic substituent. The polymer can release heat over a range of dropping ambient temperatures beginning at about 4.4 degrees C. The polymer can be formed from polymerization and/or copolymerization. The composition, when applied to at least a portion of a surface of a material, can reduce damage to the material, and/or can effectively reduce the threshold temperature at which substantial ice formation, frost damage, and/or freeze damage to the material will occur.

Certain exemplary embodiments can be useful for the protection of plants (e.g., crops, grains, tobacco, trees, nuts, flowers, vegetables, fruit, berries, and/or produce, etc.) and/or any portion thereof (i.e., “plant materials”) (e.g., seeds, seedlings, sprouts, sprigs, roots, bark, branches, stems, buds, leaves, flowers, fruit, and/or other parts of the plant) from damage via the application of an aqueous spray of specially formulated polymer and/or copolymer mixtures which can form coatings which cover the plant materials.

The coatings can be non-toxic and/or can transmit gases such as oxygen and/or carbon dioxide to and/or from the plant, but can restrict the evaporation of water from the plant which might otherwise cause the plant to cool, dry and/or shrink. The polymer (plastic) coating can undergo an exothermic phase change at or slightly above the freezing point of water, which can supply heat to the coated parts of the plant.

The polymers can be soluble and/or dispersible in water, and/or the water dispersion can have a relatively low viscosity so that it can be readily sprayed in conventional commercial spray systems.

While not being bound by any particular theory, it is believed that heat can be released over a temperature range because the polymers and/or copolymers in certain exemplary compositions can exhibit a phase change within and/or over a range of from about 4.4 degrees C. to about −6.7 degrees C., including all values therebetween, including for example about 3.21, 1, 0.86, 0.44, 0.27, 0.11, −0.01, −0.03, −1.1, −2.17, −3.06, −3.9, −6.0, etc. degrees C., and including all subranges therebetween, including from about 1.67 degrees C. to about −3.89 degrees C., from about 0 degrees C. to about 0.56 degrees C., etc.

Much of the heat released from such exemplary polymers and/or copolymers can be transferred to the plant body, which thereby can be protected from freezing. The coating layer might also insulate the plant, so that the transferred heat can be more effectively retained within the plant.

Additionally, it is believed that certain exemplary compositions might also have the ability to depress the freezing point of water that might condense and/or collect on the plant surfaces subsequent to application of the composition to the plant.

Regardless of the actual mechanism of their operation, certain exemplary compositions can be applied such that at least a portion of the plant surface is coated with the composition. Application of the compositions is not limited to any particular type of plant or to any particular stage of development of the plant or to any particular portion of the plant. Thus, certain exemplary compositions can be applied to any plant, at any stage in its development, and to any portion thereof that might benefit from protection from frost and/or freeze. Such plants include, for example, any conventional agricultural crop that may be intended for human and/or animal consumption such as fruits, vegetables, grass, hay, and so forth, or to plants grown for other purposes including, but not limited to, ornamentation, including flowers and shrubs, forestation development, erosion protection, diverse industrial applications, and so forth.

Certain exemplary compositions can be applied to plants that are immature, e.g., sprouts, seedlings, and so forth, as well as to more mature plants, e.g., those that are budding, fruit-bearing, foliage-bearing, and so forth.

Furthermore, certain exemplary compositions are not limited to application to growing plants. Thus, certain exemplary compositions can be applied to plants, or any portion thereof, that have been severed from the land, but that are still subject to environmental conditions that may result in frost and/or freeze damage thereto.

Certain exemplary compositions can be applied to the plants in any manner that results in at least a portion of the plant surface being coated with the compositions. Thus, there is no limitation to any particular mode of application. Hence any conventional method used to contact plants with liquids, semi-liquids, gels, solids, and so forth, may be employed. For example, certain exemplary compositions can be applied by spraying, for example, via nozzles or sprinkling systems, by broadcasting, dousing, soaking, and so forth using any conventional method or apparatus.

Certain exemplary compositions can be applied in the form of an aqueous solution. For example, in the case of a hydrated polymer gel, an aqueous solution of the hydrated polymer gel may be applied.

Certain exemplary compositions can also be applied in the form of water droplets coated with a polymer (e.g., microcapsules). The polymer coating the water droplets can be a hydrated polymer gel. Such coated water droplets can be formed by any conventional method including microencapsulation techniques in which water droplets are coated with a layer of a polymer. Microencapsulation is a technique for providing a thin coating on typically micron-sized particles, that may be liquid, solid, semi-solid, and so forth. A microencapsulation technique that can be used to produce coated water droplets can involve forming a mist of water droplets using an atomizing spray gun or an ultrasonic nozzle, then intersecting the stream of droplets with an orthogonal stream of droplets of the hydrated gel solution.

Other methods of forming water droplets coated with a polymer can include, for example, forming a suspension of water with a nonaqueous solution (e.g. a suspension) of the hydrated gel, then spraying the suspension through a fine nozzle. A volatile polar liquid immiscible with water can form a suspension that develops a micellar structure when water is added to the solution (or suspension) of the hydrated gel in this liquid. Polar liquids useful in this method include, for example, acetonitrile, 1-hexanol, and isopropyl ether, etc. Upon spraying, the polar liquid can be evaporated.

Prior to application of the coating layer, the size of the water droplets to be coated with a polymer can range from about 0.1 mm to about 1.0 mm, including all values therebetween, and including all subranges therebetween, such as from about 0.3 to about 0.95 mm. The thickness of the polymer layer coating the water droplets may range from about 100 microns to about 500 microns, including all values therebetween, and including all subranges therebetween, such as for example, from about 300 microns to about 500 microns.

When applying coated water droplets to plants, the coated water droplets can be applied first, followed by an aqueous solution of the polymer. However, this sequence can be reversed. By repeated application of coated water droplets and aqueous solution of the polymers, multiple layers can be achieved. By applying the composition in the form of coated water droplets, a plant to be coated with an effectively greater reservoir of water than would be the case if only the aqueous solution were applied to the plant. Moreover, in certain scenarios, it might be undesirable to include too much water in a hydrated polymer gel since the gel might become fragile and/or might lose its desired behavior of freezing over a wide temperature range. Thus, the additional water provided by the water droplets obviates using a polymer that is so hydrated that its efficacy is substantially reduced. Without being held to any particular theory of operation, it is believed that hydrogen bonding of the water encapsulated within the polymeric coating layer stabilizes the encapsulated water droplet, slows down evaporation of the water, and/or allows the coating to retain its structural integrity through several days of use. Certain exemplary polymers used to coat the water droplets include the polyacrylic acid and polyamino acid gels that are described below.

Certain exemplary compositions can also be applied in the form of a foam. When applied as a foam, the polymer can be used to entrap air bubbles to form a stable foam. It is believed that the inner and outer surfaces of the polymer undergo cross-linking through hydrogen bond formation, adding structural integrity to the foam. The foam can be formed by any conventional means, e.g., by creating air bubbles of controlled sized in a solution of the polymer gel which can lead to a stable suspension of air bubbles coated with the gel. The foam thus formed can be applied by any of the methods discussed above, including by spraying. The foam can be substantially transparent or reflective, depending on the size of the air bubbles enclosed by the polymer and/or the water content of the gel. The gel can have a water content in the range of from about 50% to about 90%, including all values and all subranges therebetween. The average diameter of the air bubbles in the foam can be in the range of from about 10 to about 100 microns. A foam having such air bubbles can reflect about 3% of the visible radiation incident upon it, provided that the polymer gel has a water content of about 70 wt. %, and the dry polymer has a refractive index about 1.50. Certain exemplary polymers can have a refractive index of the dry polymer preferably in the range of from about 1.40 to about 1.60.

Certain exemplary foams can be used in conjunction with the aqueous solution and coated water droplet forms of the composition. Thus, for example, a first layer of coated water droplets may be applied to a plant surface, followed by a layer of the aqueous solution, followed by a foam layer. It is to be understood that this sequence is merely exemplary and other sequences may be used, and multiple layers may thus be formed.

Certain exemplary compositions, when applied to at least a portion of a plant surface, can provide frost protection for several days before potentially losing efficacy due to dehydration caused by evaporation of the water molecules associated with the polymers. Even upon evaporative loss of the water molecules, it is believed that certain exemplary polymers can maintain their integrity as coatings by reorganizing their structure. Thus, certain exemplary polymers can continue to provide insulative protection to the plant, despite potentially gradually losing their ability to release heat upon encountering freezing conditions. Moreover, certain exemplary polymers can regenerate their ability to release heat upon encountering freezing conditions by being remoisturized, for example, by exposure to humid conditions, particularly rain, or if the plant is irrigated.

Certain exemplary compositions can comprise a polymer component that enhances the ability of the composition to adhere to the surface of the plant and/or to form relatively thin and/or uniform coatings on the surface of the plant. Thus, certain exemplary compositions can provide optimal frost and/or freeze protection. In certain exemplary compositions, the polymer and water associated therewith can be applied to the plant in an amount to provide a coating comprising from about 0.5% to about 3% of the weight of the plant body to be coated. In certain exemplary applications, the gel material can comprise about 30% of the weight of the coating. Thus, the gel material can comprise from about 0.15% to about 0.9% of the weight of the plant body to be coated. In a coating application where the coating comprises 1% of the weight of the plant body, the gel material will comprise 0.3% of the weight of the plant body.

Desired weight percentages can be obtained when certain exemplary compositions form a coating having a thickness in the range of from about 200 microns to about 1000 microns, including all values and subranges therebetween. These weight and thickness ranges are merely exemplary. Thus, application of a greater weight of coating material relative to the weight of the plant body, hence a greater coating thickness, can provide greater protection against frost and/or freeze. For example, a coating that is applied at a 2% level relative to the weight of the plant body can release approximately twice as much heat as would a coating applied at a 1% level. Thus, greater levels of heat can be released and a greater level of protection can be afforded when the higher coating levels are used. Extra protection may be desired, for example, when a longer spell of freezing conditions is expected or when protection is desired over a larger temperature range of the ambient air.

Certain exemplary compositions can also include other components, such as components that are non-toxic to humans, biodegradable, water soluble, water insoluble, etc., in addition to the polymer. For example, the compositions may include one or more components such as micronutrients, macronutrients, pesticides, insecticides, herbicides, rodenticides, fungicides, biocides, plant growth regulators, fertilizers, microbes, plant growth regulators, soil additives, adhesion promoting-agents, surfactants, freezing point modifiers, and so forth. Thus, certain exemplary compositions can include virtually any additional component(s) that is/are conventionally used in the treatment of plants, including additional components that are non-toxic to humans, biodegradable, water soluble, water insoluble, etc. In addition, the compositions can include components used for the treatment of soil, such as fertilizers, soil amendments, and so forth. Thus, certain exemplary compositions can function as carriers for such additional components that may be dispersed, dissolved, or otherwise incorporated within the compositions or any distinct phase or portion of such compositions.

Furthermore, certain exemplary compositions can include other additives that enhance and/or alter the properties of the coating per se without necessarily deleteriously affecting the broad freezing range of such compositions. Such additives can be non-toxic to humans, biodegradable, water soluble, water insoluble, etc. For example, freezing point modifiers, preferably freezing point depressants, can be added to certain exemplary compositions to further reduce the freezing temperature of those compositions. Such freezing point depressants include, for example, monohydric alcohols, small chain dihydroxy and polyhydroxy alcohols such as ethylene glycol and propylene glycol, among others, and polyalkylene glycols such as polyethylene glycol and polypropylene glycol, among others.

Surfactants (also known in the art as spreaders, film extenders, and/or wetting agents) such as nonionic, cationic, anionic and amphoteric surfactants, can also be included within certain exemplary compositions, including surfactants that non-toxic to humans, biodegradable, water soluble, water insoluble, etc. Ionic surfactants, for example, when added to certain exemplary compositions, can promote cross-linking of the polymers upon application to a plant surface and hence promote a more stable coating layer. On the other hand, nonionic surfactants, when added to certain exemplary compositions, can help to prevent clumping of the polymer thus facilitating a more uniform coating layer. Polyhydric alcohols can be added to an aqueous solution of certain exemplary polymer gels in order to reduce the surface energy of the hydrated gel particles. Examples of polyhydric alcohols that can be used include, for example, small chain dihydroxy and polyhydroxy alcohols such as ethylene glycol and propylene glycol, among others, and polyalkylene glycols including polyethylene glycol and polypropylene glycol, among others. By thus reducing the surface energy of the hydrated gel particles, surface wetting, and/or coverage can be increased.

Surfactants may also be used to increase the resistance of a component added to certain exemplary compositions from being removed by rain, dew, and/or irrigation. Anionic surfactants also can be helpful in preventing such additives from being readily absorbed through plant cuticles, and thus can be used when it is desired for the additive to remain on the outer surface of the plant. Non-ionic surfactants, on the other hand, can be useful when it is desired to increase the transport of such an additive through plant cuticles, and therefore can be used with systemic herbicides, nutrients, and the like.

Certain exemplary compositions can also include one or more substances that improve the adhesion of the composition, or any component within the composition, to a surface of a plant. Such adhesion-promoting substances are known in the art at “stickers”, and can be non-toxic to humans, biodegradable, water soluble, water insoluble, etc. Stickers, for example, can improve the adhesion of finely-divided solids or other water-soluble or -insoluble materials to plant surfaces. Thus, stickers can improve resistance of a plant treatment material provided as a coating to a plant surface to the effects of time, wind, water, mechanical or chemical action. For example, a sticker can improve the adhesion of a pesticide added to certain exemplary compositions against wash-off due to rainfall, heavy dew or irrigation, and also help prevent pesticide loss from wind or leaf abrasion. It is to be understood that, when added to certain exemplary compositions, stickers can improve the adhesion properties that can be inherently present in those compositions by virtue of the polymer component therein.

Certain exemplary compositions can comprise polymers that release heat over a range of dropping ambient temperatures beginning at about 1.7 degrees C. One example of a polymer that releases heat over a range of ambient temperatures beginning at about 1.7 degrees C. is a hydrolyzed polyacrylonitrile. Upon hydrolysis of polyacrylonitrile by a strong base, such as an aqueous solution of sodium hydroxide, it is believed that a copolymer of acrylamide and acrylic acid is formed. This copolymer is a water-soluble, uncross-linked polyacrylamide-acrylic acid gel that is believed to be held together by hydrogen bonds. It is believed that the polymer gel has a hydration shell surrounding the polymer chain and that the hydration shell helps to keep the polymer in aqueous solution. A slightly acidic pH range of the aqueous solution facilitates maintaining the polymer in aqueous solution. A pH of the aqueous solution of from about 5 to about 7 can be maintained in order to keep the polymer in solution. The polyacrylamide-acrylic acid gel thus formed can be hydrated to a water content in the range of from about 70 wt to about 90 wt %. As discussed above, gels having a higher water content can become fragile and/or can lose their desired freezing behavior occurring over a wide temperature range.

Certain exemplary polymers can be substantially uncrosslinked, have a relatively low amount of crosslinking, have a high decree of crosslinking, and/or be substantially crosslinked. Certain exemplary polymers can exhibit a broad freezing point transition.

The following United States patents are incorporated by reference herein in their entirety: U.S. Pat. No. 2,579,451 (Polson), U.S. Pat. No. 2,812,317 (Barrett), U.S. Pat. No. 2,861,059 (Mowry), U.S. Pat. No. 3,200,102 (Kleiner), U.S. Pat. No. 3,563,461 (Cole), U.S. Pat. No. 3,584,412 (Palmer), U.S. Pat. No. 3,615,972 (Morehouse), U.S. Pat. No. 3,709,842 (Stoy), U.S. Pat. No. 3,864,323 (Stoy), U.S. Pat. No. 3,897,382 (Stoy), U.S. Pat. No. 4,161,084 (Amy), U.S. Pat. No. 4,183,884 (Wichterle), U.S. Pat. No. 4,352,458 (Masel), U.S. Pat. No. 4,363,760 (Cioca), U.S. Pat. No. 4,419,288 (Cioca), U.S. Pat. No. 4,963,656 (Mitani), U.S. Pat. No. 5,052,618 (Carlon), U.S. Pat. No. 5,082,177 (Hill), U.S. Pat. No. 5,185,024 (Siemer), U.S. Pat. No. 5,285,769 (Wojcicki), U.S. Pat. No. 5,653,054 (Savignano), U.S. Pat. No. 5,668,082 (Miller), U.S. Pat. No. 6,057,266 (Colvin), U.S. Pat. No. 6,180,562 (Blum).

An exemplary polymer can be a hydrolyzed product of a fibrous protein such as, for example, fibrin, fibronectin, and/or elastin. Such hydrolyzed fibrous protein products can be prepared by known methods, such as enzymatic hydrolysis with an enzyme such as elastase, pepsin, and/or pronase and by nonenzymatic processes including, for example, acid and alkaline hydrolysis. It is believed that the hydrolysis product of these fibrous proteins is a polymer comprising polyamino acid moieties (i.e. polypeptides) and acrylamide moieties. An exemplary hydrolyzed fibrous protein product is a polyamino acid/polyacrylamide copolymer.

Other polymers that can useful can include, for example, polyols such as those prepared from partial hydrolysis of polysaccharides including, but not limited to starch, cellulose, and/or derivatives thereof including, e.g., hydroxypropyl methylcellulose, hydroxypropyl cellulose, and carboxymethyl cellulose. Hydroxypropyl methylcellulose can be prepared by reacting a purified form of cellulose obtained from, e.g., cotton waste or wood pulp with sodium hydroxide solution to produce a swollen alkali cellulose which then can be treated with chloromethane and propylene oxide to produce methylhydroxypropyl ethers of cellulose. The partial hydrolysis of these and other polysaccharides can be carried out by conventional processes including, e.g., alkaline or acid hydrolysis.

Certain exemplary hydrolyzed polyacrylonitriles that may be used in the certain exemplary compositions can be prepared by known methods, including both acid and alkaline hydrolysis of polyacrylonitriles to form a polymer containing acrylamide and acrylic acid moieties. An exemplary method involves hydrolyzing polyacrylonitrile by a strong base such as an aqueous solution of sodium hydroxide to produce a substantially uncrosslinked and water-soluble polyacrylamide-acrylic acid gel that is believed to be held together by hydrogen bonds. While, as discussed above, the alkaline hydrolysis product can contain both acrylamide and acrylic acid moieties, it can also contain some unhydrolyzed acrylonitrile moieties.

Polyacrylonitrile can be hydrolyzed to produce a random copolymer of acrylamide and acrylic acid. The relative ratio of acrylamide and acrylic acid can be largely dependent on the hydrolysis conditions. Control of these compositions can also be obtained by direct copolymerization of acrylic acid and acrylamide, both of which are commercially available.

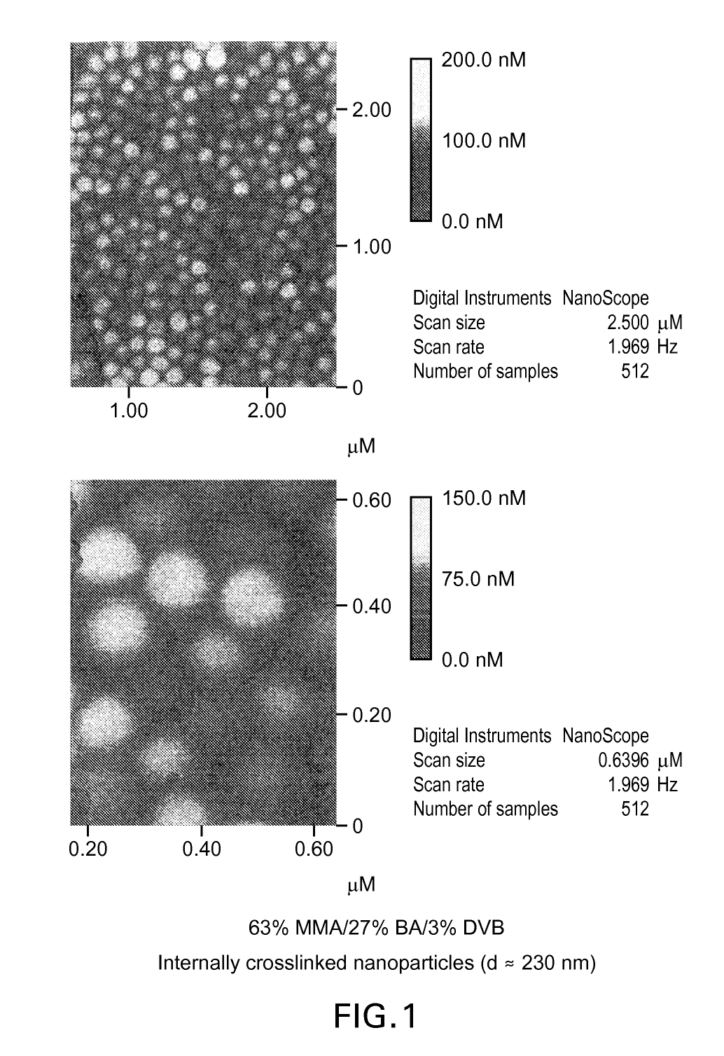

Such polymer and copolymer mixtures can be delivered as a dispersion of internally crosslinked particles that have relatively low viscosity in water and/or are relatively easy to deliver in water spray. Such polymers can be prepared by the method described by O'Callaghan et al. (Journal of Polymer Science A, vol. 33, page 1849, 1995), which is incorporated herein by reference in its entirety. Each of the resulting particles can be internally-crosslinked. Each of the particles can be substantially solid, that is, not hollow and not surrounding a liquid. Each of the particles can have a molecular weight of from about five hundred thousand (500,000) to about fifty million (50,000,000), including all values therebetween and all subranges therebetween. Each particle can be a nanoparticle, which as used herein, means a solid particle with an average major diameter of from about 2 nanometers to about 1000 nanometers, including all values therebetween, such as for example about 11, 20, 30, 41, 48, 101, 198, 235, 250, 301.4, 375, 450, 502, 625, 761.5, 850, 999, etc. nanometers, and including all subranges therebetween, such as for example from about 2 to about 200 nanometers, less than about 200 nanometers, from about 199 to about 500 nanometers, from about 11 to about 450 nanometers, less than about 450 nanometers, less than about 500 nanometers, less than about 1000 nanometers, etc. FIG. 1 is a photograph of an atomic force microscope image of internally cross-linked nanoparticles, formed via activities described herein, the nanoparticles having an average diameter of about 230 nanometers.

### EXAMPLE 1

### Preparation of an Internally Crosslinked Polymer Dispersion

To prepare a fine polymer suspension and/or dispersion by surfactant-free emulsion polymerization, the following procedure was followed. In a three-necked, 1-L round-bottom flask (flask A) fitted with a condenser with a nitrogen inlet, a mechanical stirrer and a rubber septum, 220 mL of deionized water was placed. The flask was placed into a water bath with a temperature controller set to 80 C. The bath was turned on and nitrogen was bubbled through the deionized water of the flask for ca. 1.5 h. When the temperature of the water bath reached 80 C (in about 1.5 h), a solution of ammonium persulfate (1.0 g) in 20 mL deionized water was added to flask A. The nitrogen inlet was removed temporarily from flask A and inserted in another flask (flask B) where a monomer mixture was prepared under a nitrogen blanket. The nitrogen was used to remove air from the flask, the pump, and the connecting tubes by flowing the nitrogen therethrough for about 3 to 5 minutes.

The monomer mixture of flask B contained 180 mL of water, 20 g of N-isopropylacrylamide (NIPAM) monomer, 3.72 mL of acrylonitrile monomer, and 0.6 g (2.5% on monomers) of N,N-methylene-bis-acrylamide monomer, which functioned as a cross-linker. Then the monomer mixture of flask B was slowly pumped (at a rate of 6 mL/min) from flask B into flask A in a nitrogen atmosphere. During the continuous addition of the contents of flask B to flask A, rapid polymerization created a polymer of substantially uniform concentration, the polymer an internally crosslinked copolymer of NIPAM and acrylonitrile, the polymer present in the water as a dispersion of particles. After monomer addition was completed, the contents of flask A were allowed to react for a further 2 h at 80 C. Throughout the polymerization within flask A, the reaction mixture was stirred at 300 rpm. All the monomers and other reagents were purchased from Aldrich, Calcdon, or Eastman, and used without any additional purification.

In certain exemplary embodiments, NIPAM can be copolymerized with a hydrophobic monomer such as, for example, acrylonitrile, methylmethacrylate, and/or styrene, etc. Poly(NIPAM) goes through a reversible phase transition at 31C. Cooling this polymer in water solution or dispersion would give off heat at this temperature. However, copolymerization of NIPAM with a hydrophobic monomer can reduce the temperature at which this phase transition would occur to closer to 0 C, or the freezing point of water. By carefully controlling the ratio of NIPAM to the hydrophobic monomer, the precise temperatures at which this phase transition occurs can be controlled. Moreover, by creating a mixture of more than one copolymer with varying amounts of one or more hydrophobic monomers, a broad range of phase transition could release heat over a wide range of temperatures at or near 0 C. This would then result in a wider range of frost protection for plants or crops at, above, and below the freezing point of water.

In addition, multiple polymers and/or copolymers can be provided, each releasing heat over different temperature ranges. For example, a first copolymer can release heat over a range of dropping ambient temperatures beginning at about 4.4 degrees C. to about 0 degrees C. A second copolymer can release heat over a range of dropping ambient temperatures beginning at about 1.1 degrees C. to about −4.0 degrees C. Additional copolymers can be designed, included in an aqueous solution, and applied to plants as desired to achieve different heat producing effects at various temperature ranges of interest. Thus, certain polymers and/or copolymers can protect against light or short freezes, other polymers and/or copolymers can protect against deeper or longer freezes, etc. Likewise, as desired, certain polymers and/or copolymers can be selected, produced, and/or applied to provide differing insulating properties, differing evaporative loss properties and/or differing mass transfer properties.

As mentioned above, the relative amount of hydrophobic monomer may be varied to change the temperature at which the copolymer undergoes phase transition and releases heat. In certain exemplary embodiments, mixtures can be formed that include varying amounts of copolymer whereby the copolymers in the mixture contain a different amount of a specific hydrophobic monomer. For example, the hydrophobic monomer can make up from about 1% to about 50% of the copolymer, including all values and all subranges therebetween, including from about 10% to about 40%, from about 20% to about 39.9%, and/or from about 20.1% to about 30.2% of the copolymer used in the mixture.

While two specific examples have been discussed herein, other combinations of polymers are possible and considered within the scope of the attached claims. Moreover, other ratios of hydrophobic monomers are possible and would be within the scope of the attached claims. In some cases it might be desirable to include some high molecular weight, uncrosslinked water-soluble polymers to aid in the adhesion of the coating to the plant surfaces.

### EXAMPLE 2

### Preparation of Copolymers of Methylacrylate and N-Isopropyl Acrylamide

Copolymers of Methylacrylate (MA) and N-Isopropyl Acrylamide (NIPAM) were made by polymerization in aqueous solution (or emulsion) at room temperature (25 C) in five 20 mL screw-capped Pyrex vials. NIPAM (from Eastman) and MA (from BDH) were added to the vials containing 10 mL of water containing 2 mg sodium laurate in the weight ratio shown in Table 1. Each vial was then flushed with argon followed by the addition of 5 mg ammonium persulfate (from Aldrich) and 5 mg sodium bisulfite (from Aldrich) in aqueous solution (using 10 mL of water). After further flushing with argon, each vial was closed and allowed to stand overnight (14 h) at 25 C.

Evidence for complete polymerization was the complete absence of odor (MA) in all the vials and a flocculant emulsion in the two vials with the highest amount of MA. When warmed above room temperature, all the vials showed the presence of flocculated emulsion particles, which re-dissolved when cooled to −10° C.

As the temperature was raised, the copolymers precipitated again over a range of temperatures, as shown in Table I.

TABLE I
Copolymers of MA and NIPAM

| % | % | Cloud Point | Exotherm begins | Exotherm Ends |
|---|---|---|---|---|
| MA | NIPAM | (° C.) (↑) | (° C.) (↓) | (° C.) |
| 0 | 100 | 21 | 32 | 20 |
| 20 | 80 | 17 | 26 | 2 |
| 30 | 70 | 14 | 25 | 15 |
| 40 | 60 | 0 | NA | NA |
| 50 | 50 | <−5 | NA | NA |

Referring to Table 1, the percent of MA with respect to the percent of NIPAM is shown. Also shown is the rising temperature (degrees C.) at which precipitation was first observed, which is listed as the “cloud point”. Small (1 mg) samples of the solutions were also studied by differential scanning calorimetry (DSC) to determine the dropping ambient temperatures, which are also shown, at which the exotherm began and ended, respectively.

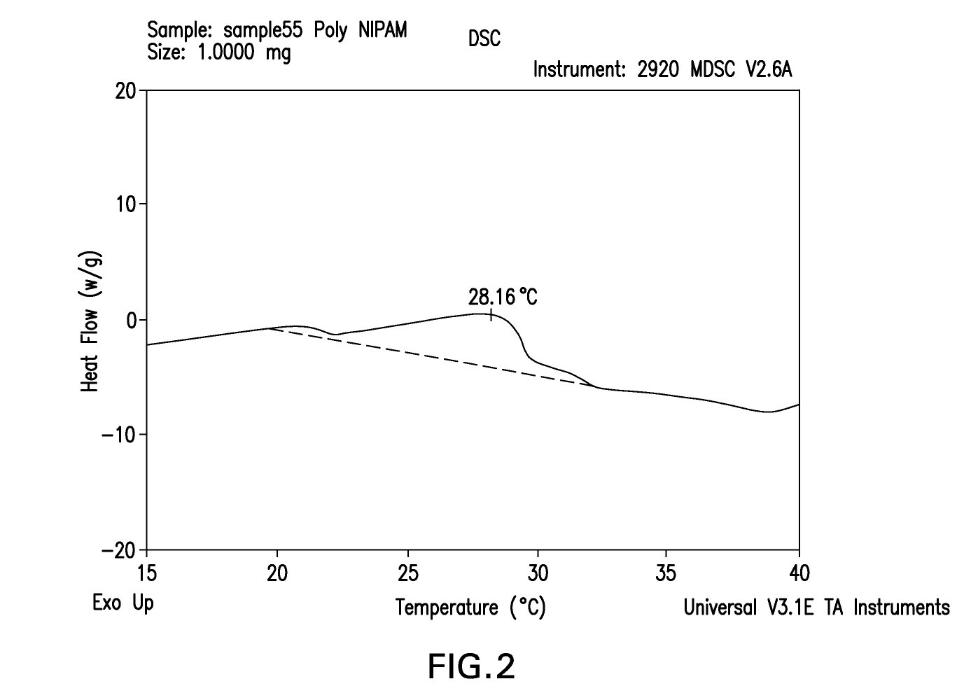

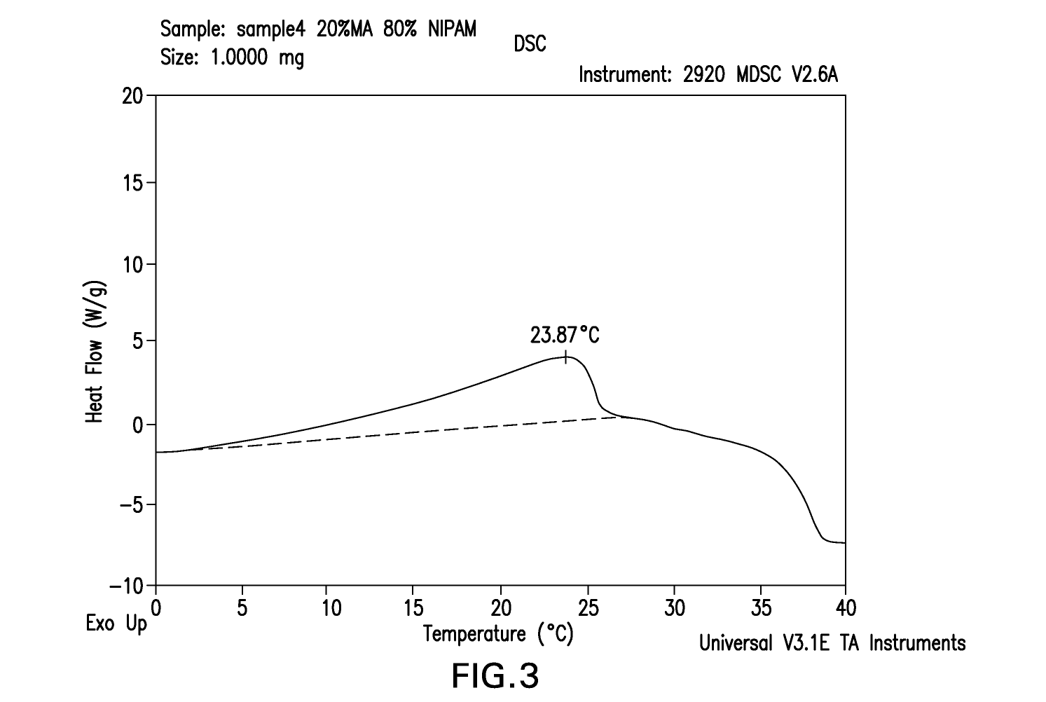

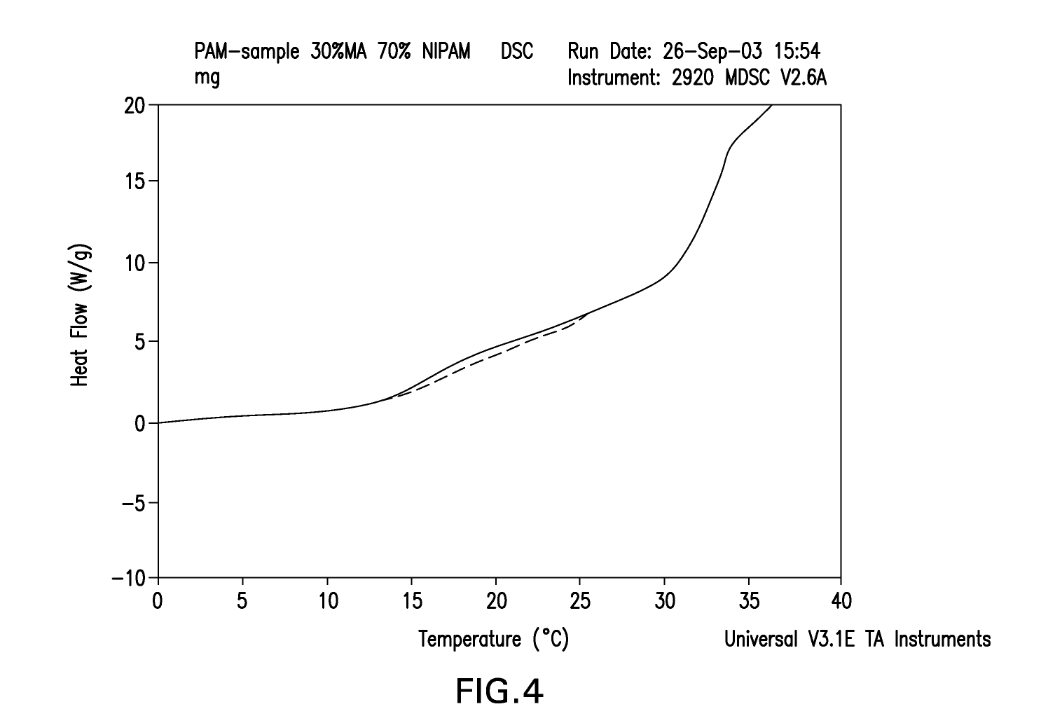

FIG. 2 is a plot, obtained from a DSC device, of heat flow versus temperature for NIPAM. FIG. 3 is a plot, obtained from a DSC device, of heat flow versus temperature for 20% MA and 80% NIPAM. FIG. 4 is a plot, obtained from a DSC device, of heat flow versus temperature for 30% MA and 70% NIPAM. Both FIGS. 2 and 3 show exotherms starting at 31C and 27C, respectively, and terminating close to 0 C, but the polymers in FIG. 4 showed no exotherm at any temperature.

The method of polymerization used in this example would lead to a relatively large range of copolymer compositions in each sample. However, using the polymerization method described in Example 1 should give narrower distributions, closer to 0 C and hence be more useful in this application.

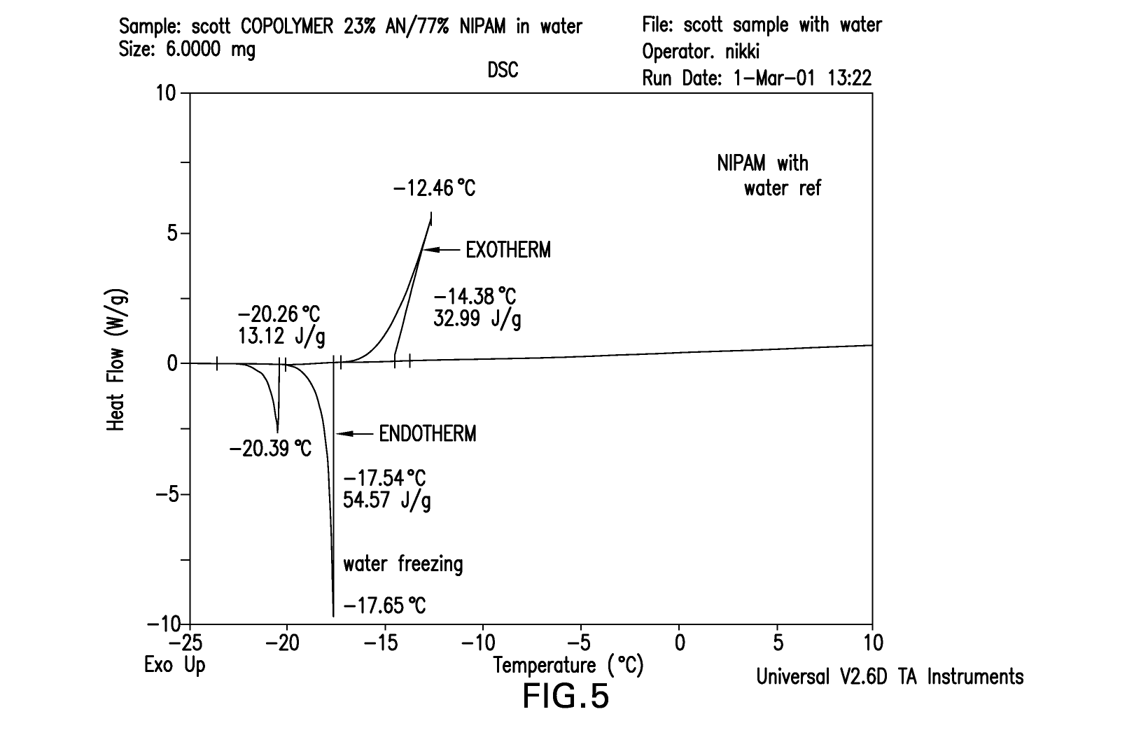

Copolymerizing different monomers with NIPAM can substantially move the exotherm range and substantially drop the peak exoterm temperature. For example, in a similar experiment, but using different monomers, i.e., 23% acrylonitrile with 87% NIPAM in water, yielded an exotherm at much lower temperature (about −12.5 C) and over a much narrower temperature range (from about −14 C to about −17.5 C). FIG. 5 is a plot, obtained from a DSC device, of heat flow versus temperature for 23% acrylonitrile and 87% NIPAM.

From these data, one can conclude (a) that copolymerization of hydrophilic monomers, such as for example, NIPAM, acrylic acid, methacrylamide, and/or acrylamide, etc., with hydrophobic monomers, such as for example MA, ethyl acrylate, butyl acrylate, and/or acrylonitrile, etc., can provide a precipitation temperature in the vicinity of 0 C and (b) that such polymers could be useful in formulating sprays to protect sensitive plants from frost.

Moreover, additional polymers could also be used. For example, the polymer could be homopolymer formed from a single monomer (e.g., vinyl-methyl alcohol) having a hydrophobic substituent (e.g., the methyl) and a hydrophilic substituent (e.g., the alcohol).

FIG. 6 is a simplified flow diagram for an exemplary method 6000. At activity 6100, a hydrophobic monomer and/or substituent can be selected and a hydrophilic monomer and/or substituent can be selected. At activity 6200, the monomers and/or substituents can be polymerized, copolymerized, and/or at least partially cross-linked. At activity 6300, an aqueous solution of polymer particles and/or nanoparticles can be formed.

At activity 6400, desired additives can be introduced to the aqueous solution, including for example, one or more micronutrients, macronutrients, pesticides, insecticides, herbicides, rodenticides, fungicides, biocides, plant growth regulators, fertilizers, microbes, soil additives, adhesion promoting-agents, surfactants, freezing point modifiers, heat releasing substances, hydrated polymer gels, foams comprising a hydrated polymer gel, and/or hydrated polymer gels comprising any of a hydrolyzed polyacrylonitrile, an uncrosslinked hydrolyzed polyacrylonitrile, a hydrolyzed fibrous protein, a hydrolyzed fibrous protein comprising amino acid and acrylamide moieties, and/or a hydrolyzed fibrous protein selected from hydrolyzed fibronectin, hydrolyzed fibrin, and hydrolyzed elastin, etc. Alternatively, the additives can be applied to the plant before, during, and/or after application of the solution.

At activity 6500, the solution (and/or additives, if applied separately from the solution) can be sprayed or otherwise directed toward one or more desired surfaces, such as a portion of a plant, aircraft, roadway, walkway, etc. The solution (and/or additives) can include water droplets comprising a dispersion of polymer particles and/or water droplets coated with a polymer, such as a hydrated polymer gel. The solution (and/or additives) can be provided as a foam having air bubbles having a diameter in the range of from about 10 microns to about 100 microns. At activity 6600, at least a portion of a surface can be coated by the solution (and/or additives). After application the solution (and/or additives) can dry, cure, harden, solidify, become more viscous, foam, polymerize, etc.

At activity 6700, the applied materials (e.g., solution, additives, etc.) can experience adverse conditions, such as dropping ambient temperatures, frost, freeze, dew, drought, low humidity, high humidity, and/or high temperatures, etc. At activity 6800, the polymer particles and/or applied materials can release heat, prevent ice formation, provide insulation, provide impact protection, reduce evaporative losses, allow transpiration, restrict transpiration, restrict mass transfer, and/or block and/or resist and/or repel diseases and/or pests, etc., to and/or from the coated surfaces. Thus, the applied materials can protect the coated surface and/or a portion thereof, from ice formation and/or from damage due to frost, freeze, drying, wilting, transport, impact, bruising, abrasion, vibration, premature ripening, rot, disease, and/or pests, etc.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, field, background, summary, abstract, drawing figure, etc.) of this application, unless clearly specified to the contrary, there is no requirement for the inclusion in any claim of the application of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, then any such conflicting information in such incorporated by reference material is specifically not incorporated by reference herein.

What is claimed is:

1. A method comprising a plurality of activities comprising:
providing a solution comprising water and a dispersion of solid particles comprising an internally crosslinked polymer comprising at least one hydrophobic substituent and at least one hydrophilic substituent; and
coating at least a portion of a surface of a plant with the solution.

2. The method of claim 1, wherein:
the particles are nanoparticles.

3. The method of claim 1, wherein:
each of the particles has a molecular weight of from about 500,000 to about 50,000,000.

4. The method of claim 1, wherein:
the particles have an average diameter of from about 2 nanometers to about 1000 nanometers.

5. A method comprising a plurality of activities comprising:
providing a solution comprising water and a dispersion of solid particles comprising an internally crosslinked polymer comprising at least one hydrophobic substituent and at least one hydrophilic substituent;
coating at least a portion of a surface with the solution; and
preventing the formation of ice on the surface.

6. A method comprising a plurality of activities comprising:
polymerizing at least one hydrophobic substituent and at least one hydrophilic substituent to form solid nanoparticles having an average diameter of from about 11 nanometers to about 450 nanometers, the nanoparticles comprising a an internally crosslinked polymer comprising the at least one hydrophobic substituent and the at least one hydrophilic substituent; and
forming a solution comprising water and a dispersion of the solid nanoparticles.
